(19) United States
(12) Patent Application Publication
(10) Pub. No.: US 2012/0052379 A1
(43) Pub. Date: Mar. 1, 2012

(54) Electrode for rechargeable lithium battery, method of preparing same, and rechargeable lithium battery including same

(76) Inventors: Sae-Weon Roh, Yongin-si (KR); Man-Seok Han, Yongin-si (KR); Tae-Keun Kim, Yongin-si (KR); Sung-Soo Kim, Yongin-si (KR); Jin-Kyu Hong, Yongin-si (KR)

(21) Appl. No.: 13/135,370

(22) Filed: Jun. 30, 2011

(30) Foreign Application Priority Data
Aug. 27, 2010 (KR) 10-2010-0083543

(51) Int. Cl. H01M 4/62; H01M 4/64; H01M 10/00; B05D 5/12

(52) U.S. Cl. 429/211; 427/58

(57) ABSTRACT

An electrode for a rechargeable lithium battery includes a current collector; a first active material layer on the current collector, the first active material including a first binder, an active material, and a conductive material; and a second active material layer on the first active material layer, the second active material including a second binder including a copolymer, an active material, and a conductive material. A method of preparing the electrode is also provided. A rechargeable lithium battery includes the electrode.

### CROSS-REFERENCE TO RELATED APPLICATION

This application claims priority to and the benefit of Korean Patent Application No. 10-2010-0083543, filed in the Korean Intellectual Property Office on Aug. 27, 2010, the entire content of which is incorporated herein by reference.

### BACKGROUND

1. Field

This disclosure relates to an electrode for a rechargeable lithium battery, a method of preparing the same, and a rechargeable lithium battery including the same.

2. Description of the Related Art

Lithium rechargeable batteries have recently drawn attention as a power source for small portable electronic devices. In part due to the use of an organic electrolyte, lithium rechargeable batteries have twice the discharge voltage of conventional batteries that use an alkali aqueous solution. Accordingly, lithium rechargeable batteries have relatively high energy density.

However, to be commercially viable, small lithium batteries for use in small portable electronic devices should be produced on a large scale, and should also cost less per volume to make than commercially available medium-sized and large-sized rechargeable lithium batteries. The cost of the capacity of a battery may be decreased by placing a thick active material layer on a current collector. An active material layer may be formed by coating an active material composition on a current collector and drying and compressing it. Prior to compression, the active material layer is about 300 μm thick, and after compression, the active material layer is about 100 μm thick.

However, this method of forming the active material layer may cause micro- or macro-cracks on the surface of an electrode. These cracks may be caused by non-uniform drying. This non-uniform morphology of an electrode may disturb the electrode's electrical network and decrease adherence of the active material layer to the current collector, therefore failing to adequately fabricate an electrode. In addition, a current collector with a thick active material layer may have bad wettability, which may hamper diffusion of lithium ions and resultantly deteriorate rate capability and cycle life of a battery.

### SUMMARY

An exemplary embodiment of the present invention is directed to an electrode for a rechargeable lithium battery that has an electrode with a thick active material having a reduced amount of or no cracks, even at a compressed thickness of about at least 150 μm, has good adherence to a current collector, and has improved wettability. Accordingly, embodiments of the invention have improved rate capability and cycle life.

An exemplary embodiment includes a method of fabricating the electrode.

Another exemplary embodiment of the present invention provides a rechargeable lithium battery including the electrode.

According to an embodiment of the present invention, an electrode for a rechargeable lithium battery includes a current collector, a first active material layer on the current collector, and a second active material layer on the first active material layer. The first active material layer includes a first binder, an active material, and a conductive material. The second active material layer includes a second binder including a polymer, an active material, and a conductive material. The first and second active material layers may have a combined thickness of about 150 μm to about 1000 μm.

The first binder may include one of polyvinylidene fluoride (PVdF), carboxylmethyl cellulose (CMC), a styrene-butadiene rubber (SBR), a polyimide (PI), a polyamideimide (PAI), polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, or combinations thereof.

The first active material layer may be about 100 μm to about 500 μm thick.

The second binder may include a copolymer of hexafluoro propylene (HFP) and a material selected from polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, or combinations thereof.

The second binder may include about 1 wt % to 20 wt % of hexafluoro propylene based on the weight of the second binder.

The second active material layer may have a thickness of about 50 μm to 500 μm.

According to an embodiment of the present invention, a method of manufacturing an electrode for a rechargeable lithium battery is provided. The method includes preparing a first active material composition by mixing a first binder, an active material, and a conductive material in a solvent and preparing a second active material composition by mixing a second binder, an active material, and a conductive material in a solvent. The first active material layer is formed on at least one side of a current collector by coating the first active material composition thereon and drying it. The second active material layer is formed on the first active material layer by coating the second active material composition thereon and drying it. The second active material layer and the first active material layer are compressed on the current collector.

The first binder may include polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, or combinations thereof.

The first active material layer may have a thickness of about 200 μm to about 1000 μm before the compression, and about 100 μm to about 500 μm after the compression.

The second binder may include a copolymer of hexafluoro propylene and a material selected from polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, or combinations thereof.

The second binder may include about 1 wt % to about 20 wt % of hexafluoro propylene based on the weight of the second binder. In another embodiment, the second binder may include about 1 wt % to about 10 wt % of hexafluoro propylene based on the weight of the second binder.

The second active material layer may have a thickness of about 100 μm to about 1000 μm before the compression and about 50 μm to 500 μm after the compression.

The first and second active material layers may have a combined thickness of about 300 μm to about 2000 μm before the compression and about 150 μm to about 1000 μm after the compression.

The first or second active material compositions may include the active material at about 80 wt % to about 97 wt %, the conductive material at about 1.5 wt % to about 10 wt %, and the first or second binder at about 1.5 wt % to about 10 wt %.

According to another embodiment of the present invention, a rechargeable lithium battery includes the electrode.

A rechargeable lithium battery including the electrode according to an embodiment of the present invention has improved capacity and cycle life.

### BRIEF DESCRIPTION OF THE DRAWINGS

These and/or other aspects will become apparent and more readily appreciated from the following description of the embodiments, taken in conjunction with the accompanying drawings in which:

FIG. 1 depicts the structure of a rechargeable lithium battery according to one embodiment of the present invention;

FIGS. 2A, 2B, and 2C are scanning electron microscope (SEM) photographs taken of the surface of the positive electrodes of Example 1 and Comparative Examples 2 to 3, respectively;

FIG. 3 is a graph showing rate characteristics of half-cells including the positive electrodes of Example 1 and Comparative Example 1;

FIG. 4 is a graph showing the cycle characteristic of half-cells including the positive electrodes of Example 1 and Comparative Example 1; and

FIG. 5 is a schematic view of an electrode according to one embodiment of the present invention.

### DETAILED DESCRIPTION

The following detailed description references certain exemplary embodiments, examples of which are illustrated in the accompanying drawings. Throughout the description, like reference numerals refer to like elements. In this regard, the described embodiments are exemplary, and those of ordinary skill in the art will appreciate that certain modifications can be made to the described embodiments. This description is not limited to the particular embodiments described.

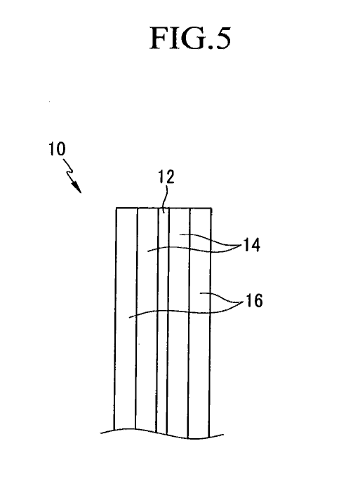

As shown in FIG. 5, according to exemplary embodiments, an electrode 10 for a rechargeable lithium battery includes: a current collector 12; a first active material layer 14 that is disposed on the current collector 12 and includes a first binder, an active material, and a conductive material; and a second active material layer 16 that that is disposed on the first active material layer 14 and includes a second binder including a polymer, an active material, and a conductive material.

The first binder improves binding properties of the positive active material particles to one another and the positive active material with a current collector. The first binder may include at least one of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, or an epoxy resin. In exemplary embodiments, the first binder includes polyvinylidene fluoride.

The first binder is included in the first active material layer and contacts a current collector. The first binder may strongly adhere the first active material layer to the current collector.

The first binder may be included at about 1.5 wt % to about 10 wt % based on the weight of the first active material layer. In exemplary embodiments, the first binder may be included at about 3 wt % to about 7 wt % based on the weight of the first active material layer. When the first binder is included within the disclosed range, it may promote improved adherence of an active material to a current collector, and furthermore improve the electrical conductivity and energy density of a substrate.

The active material may be a negative or positive active material. When the active material is a positive active material, the active material may be increasingly loaded on a current collector, providing additional battery capacity.

Non-limiting examples of suitable negative active materials include materials that reversibly intercalate/deintercalate lithium ions, a lithium metal, lithium metal alloys, materials capable of doping and dedoping lithium, materials capable of reacting with lithium ions to form lithium-containing compounds, and transition metal oxides.

Examples of lithium metal alloys include alloys of lithium and a metal such as Na, K, Rb, Cs, Fr, Be, Mg, Ca, Sr, Si, Sb, Pb, In, Zn, Ba, Ra, Ge, Al, and Sn.

Examples of transition metal oxides, materials capable of doping and dedoping lithium, and materials capable of reacting with lithium ions to form lithium-containing compounds include vanadium oxide, lithium vanadium oxide, Si, SiOₓ (0<x<2), Si-Q (where Q is an alkali metal, alkaline-earth metal, group 13 element, group 14 element, transition element, rare earth element, or a combinations thereof, except that Q is not Si), Sn, SnO₂, Sn-Q (where Q is an alkali metal, alkaline-earth metal, group 13 element, group 14 element, transition element, rare earth element, or a combinations thereof, except that Q is not Si), or mixtures thereof. In exemplary embodiments, each Q may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. In exemplary embodiments, the negative active material can include SiO₂ and at least one of the other above described transition metal oxides, materials capable of doping and dedoping lithium, or materials capable of reacting with lithium ions to form lithium-containing compounds.

Materials that reversibly intercalate/deintercalate lithium ions include carbon materials. Carbon materials may be any carbon-based negative active material that is conventionally used in a lithium ion rechargeable battery. Non-limiting examples of the carbon material include crystalline carbon, amorphous carbon, and mixtures thereof. The crystalline carbon may be non-shaped or sheet, flake, spherical, or fiber shaped natural graphite or artificial graphite. The amorphous carbon may be a soft carbon, a hard carbon, mesophase pitch carbide, fired coke, or the like.

The positive active material includes lithiated intercalation compounds that reversibly intercalate and deintercalate lithium ions. The positive active material may include a composite lithium oxide including at least one of cobalt, manganese, or nickel. In exemplary embodiments, one or more of the following lithium-containing compounds may be used.

LiₐA_{1-b}X_{b}D₂ (0.90≦a≦1.8 and 0≦b≦0.5); LiₐE_{1-b}X_{b}O_{2-c}D_{c} (0.90≦a≦1.8, 0≦b≦0.5, and 0≦c≦0.05); LiₐE_{2-b}X_{b}D₄ (0.90≦a≦1.8, 0≦b≦0.5); LiₐE_{2-b}X_{b}O_{4-c}D_{c} (0.90≦a≦1.8, 0≦b≦0.5, and 0≦c≦0.05); LiₐNi_{1-b-c}Co_{b}X_{c}Dₐ (0.90≦a≦1.8, 0≦b≦0.5, 0≦c≦0.05, and 0<α≦2); LiₐNi_{1-b-c}Co_{b}X_{c}O_{2-α}T_{α} (0.90≦a≦1.8, 0≦b≦0.5, 0≦c≦0.05, and 0<α<2); LiₐNi_{1-b-c}Co_{b}X_{c}O_{2-α}T₂ (0.90≦a≦1.8, 0≦b≦0.5, 0≦c≦0.05, and 0<α<2); LiₐNi_{1-b-c}Mn_{b}X_{c}D_{α}(0.90≦a≦1.8, 0≦b≦0.5, 0≦c≦0.05, and 0<α≦2); LiₐNi_{1-b-c}Mn_{b}X_{c}O_{2-α}T_{α} (0.90≦a≦1.8, 0≦b≦0.5, 0≦c≦0.05, and 0<α<2); LiₐNi_{1-b-c}Mn_{b}X_{c}O_{2-α}T₂ (0.90≦a≦1.8, 0≦b≦0.5, 0≦c≦0.05, and 0<α<2); LiₐNi_{b}E_{c}G_{d}O₂ (0.90≦a≦1.8, 0≦b≦0.9, 0≦c≦0.5, and 0.001≦d≦0.1); LiₐNi_{b}Co_{c}Mn_{d}GₑO₂ (0.90≦a≦1.8, 0≦b≦0.9, 0≦c≦0.5, 0≦d≦0.5, and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiZO₂; LiNiVO₄; Li_{(3-f)}J₂(PO₄)₃(0≦f≦2); Li_{(3-f)}Fe₂(PO₄)₃ (0≦f≦2); LiFePO₄

In the above formulae, A may be Ni, Co, Mn, or combinations thereof; X may be Al, Ni, Co, Mn, Cr, Fe, Mg, Sr, V, a rare earth element, or combinations thereof; D may be O, F, S, P, or combinations thereof; E may be Co, Mn, or combinations thereof; T may be F, S, P, or combinations thereof; G may be Al, Cr, Mn, Fe, Mg, La, Ce, Sr, V, or combinations thereof; Q may be Ti, Mo, Mn, or combinations thereof; Z may be Cr, V, Fe, Sc, Y, or combinations thereof, and J may be V, Cr, Mn, Co, Ni, Cu, or combinations thereof.

The lithiated intercalation compound of the positive active material may have a coating layer on its surface or may be mixed with a compound having a coating layer.

The coating layer may include at least one coating element compound selected from a coating element, a hydroxide of a coating element, an oxyhydroxide of a coating element, an oxycarbonate of a coating element, or a hydroxyl carbonate of a coating element. Compounds of a coating layer may be amorphous or crystalline. The coating element of the coating layer may be Mg, Al, Co, K, Na, Ca, Si, Ti, V, Sn, Ge, Ga, B, As, Zr, or mixtures thereof. The coating layer may be formed in any method having no adverse effect on properties of the positive active material as a result of adding these elements to the compound. For example, the method may include a coating method such as spray coating, dipping, and the like. However, these methods will not be described here in more detail, as coating methods are well-known to those skilled in the art.

The active material may be included at about 80 wt % to about 97 wt % based on the weight of the first active material layer. In exemplary embodiments, the active material may be included at about 87 wt % to about 93 wt % based on the weight of the first active material layer. When the active material is included within this range, capacity and thus energy density and performance of a rechargeable battery may be increased.

The conductive material may be used in order to improve the conductivity of an electrode. The conductive material may include any electrically conductive material that does not cause a chemical change in the battery. Non-limiting examples of the conductive material include carbon-based materials such as natural graphite, artificial graphite, carbon black, acetylene black, ketjen black, carbon fiber, and the like; metal-based materials such as metal powders or metal fibers of copper, nickel, aluminum, silver, and the like; conductive polymer materials such as polyphenylene derivatives; and mixtures thereof. In an exemplary embodiment, the conductive material includes carbon black.

The conductive material may be included in an amount of about 1.5 wt % to about 10 wt % based on the entire weight of the first active material layer, or about 3 wt % to about 7 wt % in another embodiment. When the conductive material is included within the range, it may increase adherence of an active material to a current collector and thus improve electrical conductivity and energy density.

The first active material layer including the first binder, the active material, and the conductive material may have a thickness of about 100 μm to about 500 μm. In exemplary embodiments, the first active material layer has a thickness of about 50 μm to about 250 μm. When the first active material layer has a thickness within this range, processibility and electrical conductivity of a battery may be improved.

The second active material layer may include a second binder, an active material, and a conductive material.

The second binder may include a copolymer of hexafluoro propylene and at least one of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, or an epoxy resin. In an exemplary embodiment, the second binder includes a copolymer of polyvinylidene fluoride and hexafluoro propylene. The second binder may include about 1 wt % to about 20 wt % of hexafluoro propylene based on the weight of the second binder. Alternatively, the second binder may include about 1 wt % to about 10 wt % of hexafluoro propylene based on the weight of the second binder.

The second binder is included in the second active material layer and thus contacts the first active material layer and the electrolyte. The second binder may improve wettability of the electrode and adhere the second active material layer to the first active material layer.

The second binder may be included at about 1.5 wt % to about 10 wt % based on the weight of the second active material layer. In exemplary embodiments, the second binder may be included at about 3 wt % to about 7 wt % based on the weight of the second active material layer. When the second binder is included within this range, wettability of the electrode and adherence of the second active material layer to the current collector may be improved.

The active material and the conductive material for the second active material layer may be the same as those for the first active material layer, and furthermore, may be included in the same amounts.

The second active material layer including the second binder, the active material, and the conductive material may have a thickness of about 50 μm to about 500 μm. In exemplary embodiments, the second active material layer may have a thickness of about 5 μm to about 250 μm. When the second active material layer has a thickness within this range, the second active material layer may have improved wettability, and thus the battery characteristics may be improved. Additionally, when the second active material layer is within this range, the process of manufacturing a battery including the second active material layer is also improved.

Accordingly, the combined first and second active material layers may have a thickness of about 150 μm to about 1000 μm. When the second active material layer is thicker than the first active material layer, a battery including the two layers may have an improved rate capability.

The negative electrode may include a current collector made of a copper foil, a nickel foil, a stainless steel foil, a titanium foil, a nickel foam, a copper foam, a polymer substrate coated with a conductive metal, or combinations thereof. The positive electrode may include a current collector made of an aluminum foil.

According to one embodiment of the present invention, an electrode for a rechargeable lithium battery may include a thick active material layer having two layers each including different binders on a current collector and having no cracks. In other words, it may include a thick active material layer with excellent adherence to a current collector and morphology that does not disturb the electrical network of an electrode, and additionally has excellent wettability, improving rate capability and cycle life.

If the first active material having the first binder is not included in the electrode, the cracks may be formed in the active material layer. That is, it is difficult to suitably prepare an electrode including a single active material layer having the second binder, thus it is difficult to apply such an active material layer to the batteries.

According to another embodiment of the present invention, a method of manufacturing an electrode for a rechargeable lithium battery includes: preparing a first active material composition by mixing a first binder, an active material, and a conductive material in a solvent and preparing a second active material composition by mixing a second binder, an active material, and a conductive material in a solvent. A first active material layer is formed by coating the first active material composition on at least one side of a current collector. A second active material layer is formed by coating the second active material composition on the first active material layer. The second active material layer and the first active material layer may be dried and compressed on the current collector. The first active material layer may be dried before forming the second active material layer. The second active material layer may be dried prior to compression.

The first and second binders, the active material, the conductive material, and the current collector may be the same as described in the above electrode for a rechargeable lithium battery.

Solvents used in the first active material composition and the second active material composition may be different from each other in order to prevent intermixing of the two layers and to prevent collapse of the first active material layer during coating of the second active material layer. Non-limiting examples of the solvent used in the first or the second active material composition include N-methylpyrrolidone (NMP); hexane; water; alcohols such as methanol, ethanol, propanol, isopropanol, butanol, isobutanol, s-butanol, t-butanol, pentanol, isopentanol, hexanol, and the like; ketones such as acetone, methylethyl ketone, methylpropyl ketone, ethylpropyl ketone, cyclopentanone, cyclohexanone, cycloheptanone, and the like; ethers such as methylethylether, diethylether, dipropylether, diisopropylether, dibutylether, diisobutylether, di-n-amylether, diisoamylether, methylpropylether, methylisopropylether, methylbutylether, ethylpropylether, ethylisobutylether, ethyl n-amylether, ethylisoamylether, tetrahydrofuran, and the like; lactones such as gamma-butyrolactone, delta-butyrolactone, and the like; lactams such as beta-lactam; cyclic aliphatics such as cyclopentane, cyclohexane, cycloheptane, and the like; aromatic hydrocarbons such as benzene, toluene, o-xylene, m-xylene, p-xylene, ethylbenzene, propylbenzene, isopropylbenzene, butylbenzene, isobutylbenzene, n-amylbenzene, and the like; aliphatic hydrocarbons such as heptane, octane, nonane, decane, and the like; linear and cyclic amides such as dimethyl formamide, N-methylpyrrolidone, and the like; esters such as methyl lactate, ethyl lactate, propyl lactate, butyl lactate, methyl benzoate, and the like; and electrolytic solvents that will be described hereafter, however, any suitable electrolytic solvents may be used. The solvents may be used as mixtures, for instance, between two to five solvents may be used.

The first or second active material composition may include an active material at about 80 wt % to about 97 wt % based on the weight of the active material composition, a conductive material at about 1.5 wt % to about 10 wt % based on the weight of the active material composition, and the first or second binder at about 1.5 wt % to about 10 wt % based on the weight of the active material composition.

According to an embodiment of the present invention, the method of manufacturing an electrode for a rechargeable lithium battery may form a thick active material layer coating two active material compositions including different binders on a current collector.

The first active material layer may have a thickness of about 200 μm to about 1000 μm before the compression and about 100 μm to about 500 μm after compression. The second active material layer may have a thickness of about 100 μm to about 1000 μm before compression and about 50 μm to about 500 μm after compression. The first and second active material layers together may have a thickness of about 300 μm to about 2000 μm before compression and about 150 μm to about 1000 μm after compression. According to another embodiment of the present invention, the first and second active material layers together may be about 300 μm or more thick before compression and about 150 μm or more thick after compression.

When an active material having a single layer has a thickness of about 300 μm or more in a conventional battery, it may crack. However, when an active material layer is formed by laminating two thin layers, it may not crack and have improved thickness.

Another embodiment of the present invention includes a rechargeable lithium battery fabricated using an electrode according to the above described embodiment of the present invention. The electrode according to one embodiment of the present invention may be applied to a positive or negative electrode. When the dual layer active material is applied to a positive electrode, the negative electrode may include a binder that is conventionally used, and when it is applied to a negative electrode, the positive electrode may include a binder that is conventionally used.

Conventional binders include polyvinyl alcohol, carboxylmethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, however any suitable binder may be used.

The rechargeable lithium battery includes an electrolyte. Non-limiting examples of the electrolyte include a lithium salt dissolved in a non-aqueous organic solvent (electrolytic solvent), a polymer electrolyte, an inorganic solid electrolyte, and a composite material with polymer electrolyte and inorganic solid electrolyte.

The non-aqueous organic solvent serves as a medium for transmitting ions taking part in the electrochemical reaction of the battery. Non-limiting examples of the non-aqueous organic solvent include carbonate-based, ester-based, ether-based, ketone-based, alcohol-based, and aprotic solvents. Non-limiting examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Non-limiting examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and the like. Non-limiting examples of the ether-based solvent include dibutyl ether, tetraglyme, diglyme, 1,2-dimethoxy ethane, 1,2-diethoxy ethane, ethoxymethoxy ethane, 2-methyltetrahydrofuran, tetrahydrofuran, and the like. Non-limiting examples of the ketone-based solvent include cyclohexanone and the like. Non-limiting examples of the alcohol-based solvent include ethanol, isopropyl alcohol, and the like. Non-limiting examples of the aprotic solvent include nitriles such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and the like. One non-aqueous organic solvent may be used or mixtures of non-aqueous organic solvents may be used. When mixtures of organic solvents are used, the mixture ratio may be controlled in accordance with desirable battery performance.

The carbonate-based solvent may include a mixture of a cyclic carbonate and a linear carbonate. The cyclic carbonate and the chain carbonate may be mixed together in the volume ratio of about 1:about 1 to about 1:about 9. When the mixture is used as an electrolyte, the electrolyte may have improved performance.

The non-aqueous organic solvent may further include an aromatic hydrocarbon-based organic solvent in addition to a carbonate-based solvent. The carbonate-based solvents and the aromatic hydrocarbon-based solvents may be mixed together in the volume ratio of about 1:about 1 to about 30:about 1.

The aromatic hydrocarbon-based organic solvent may be represented by Chemical Formula 1

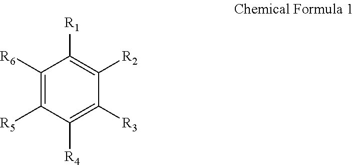

Each of R₁ to R₆ is independently selected from hydrogen, halogens, C1 to C10 alkyls, or C1 to C10 haloalkyls.

Non-limiting examples of the aromatic hydrocarbon-based organic solvent include at least one of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include vinylene carbonate or an ethylene carbonate-based compound represented by Chemical Formula 2.

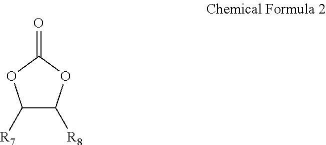

Each of R₇ and R₈ is independently selected from hydrogen, halogens, a cyano group (CN), a nitro group (NO₂), or C1 to C5 fluoroalkyl groups, provided that at least one of R₇ and R8 is a halogen, a nitro group (NO₂), or a C1 to C5 fluoroalkyl group and R₇ and R₈ are not simultaneously hydrogen.

Non-limiting examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. The use of the ethylene carbonate-based compound additive may improve cycle life, and its amount may be adjusted within an appropriate range.

The lithium salt is dissolved in an organic solvent, and supplies lithium ions in the battery and thus operates a basic operation of a rechargeable lithium battery. The lithium salt also improves transportation of lithium ions between positive and negative electrodes. Non-limiting examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiCF₃SO₃, LiC₄F₉SO₃, LiC₆H₅SO₃, LiSCN, LiClO₄, LiAlO₂, LiAlCl₄, LiN(CₓF₂ₓ₊₁SO₂)(C_{y}F_{2y+1}SO₂)(where x and y are natural numbers), LiCl, LiI, and LiB(C₂O₄)₂ (lithium bisoxalato borate—LiBOB). The lithium salt may be used in a concentration of about 0.1M to about 2.0M. When the lithium salt is included at the above concentration range, electrolyte performance and lithium ion mobility may be improved due to optimal electrolyte conductivity and viscosity.

The rechargeable lithium battery may further include a separator between a negative electrode and a positive electrode, as needed. Non-limiting examples of suitable separator materials include polyethylene, polypropylene, polyvinylidene fluoride, and multiple layers thereof. Exemplary embodiments include a polyethylene/polypropylene double-layered separator, a polyethylene/polypropylene/polyethylene triple-layered separator, and a polypropylene/polyethylene/polypropylene triple-layered separator.

In general, rechargeable lithium batteries may be classified as lithium ion batteries, lithium ion polymer batteries, and lithium polymer batteries according to the presence of a separator and the kind of electrolyte used in the battery. Rechargeable lithium batteries may have a variety of shapes and sizes, including cylindrical, prismatic, or coin-type batteries, and may also be a thin film or rather bulky type depending on its size. Structures and fabricating methods for lithium ion batteries pertaining to the present invention are well known in the art.

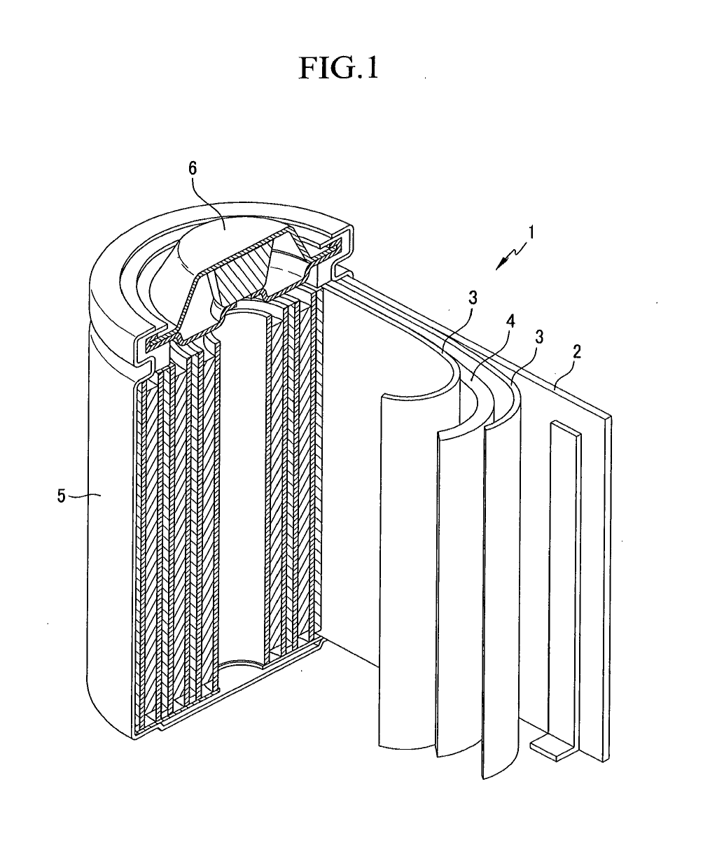

FIG. 1 is a schematic cross-sectional view showing a rechargeable lithium battery according to one embodiment of the present invention. The battery of the present invention is not limited to FIG. 1 but may be fabricated into a prismatic, coin-type, button-type, laminated sheet-type, and flat, cylindrical, and the like, which is suitably designed depending upon the application.

Referring to FIG. 1, the rechargeable lithium battery 1 includes a battery case 5 including a negative electrode 2, a positive electrode 4, and a separator 3 interposed between the positive electrode 4 and the negative electrode 2, an electrolyte impregnated therein, and a sealing member 6 sealing the battery case 5.

The negative electrode 2 and positive electrode 4 may be fabricated by forming a negative electrode or positive active material slurry including each negative active material or positive active material on a current collector.

The following examples illustrate the present invention in more detail. These examples, however, should not in any sense be interpreted as limiting the scope of the present invention.

### Preparation of Positive Active Material Slurry

### Preparation Example 1

90 wt % of a LMO (LiMn₂O₄) positive active material was mixed with 5 wt % of a polyvinylidene fluoride homopolymer binder and 5 wt % of a carbon black conductive material (Super P) in an N-methylpyrrolidone solvent, preparing a positive active material slurry.

### Preparation Example 2

90 wt % of a LMO (LiMn₂O₄) positive active material, 5 wt % of a copolymer of polyvinylidene fluoride and hexafluoro propylene mixed at 9:1 weight ratio as a binder, and 5 wt % of a carbon black conductive material were mixed in an acetone solvent, preparing a positive active material slurry.

### Fabrication of Electrode

### Example 1

The positive active material slurry of Preparation Example 1 was coated to be 300 μm thick on an aluminum foil current collector to prepare a first positive active material, and the positive active material slurry of Preparation Example 2 was coated to be 200 μm thick on the first positive active material to prepare a second positive active material. The resulting product was dried and compressed at 120° C. for 1 hour, fabricating an electrode with a 250 μm-thick active material layer according to Example 1.

### Comparative Example 1

The positive active material slurry of Preparation Example 1 was coated to be 500 μm thick on an aluminum foil current collector and dried and compressed at 120° C. for 1 hour, fabricating an electrode with a 250 μm-thick active material layer according to Comparative Example 1.

### Comparative Example 2

The positive active material slurry of Preparation Example 1 was coated to be 300 μm thick on an aluminum foil current collector and then dried and compressed at 120° C. for 1 hour, fabricating an electrode with a 150 μm-thick active material layer according to Comparative Example 2.

### Comparative Example 3

The positive active material slurry of Preparation Example 2 was coated to be 300 μm thick on an aluminum foil current collector and then dried and compressed at 120° C. for 1 hour, fabricating an electrode with a 150 μm-thick active material layer according to Comparative Example 3.

### Fabrication of Rechargeable Lithium Battery Cell

Each positive electrode according to Example 1 and Comparative Examples 1 to 3 was used with a lithium metal as a counter electrode against the positive electrode, fabricating coin-type half-cells. An electrolyte was prepared by mixing ethylene carbonate, dimethyl carbonate, and ethylmethyl carbonate in a volume ratio of 3:4:3 to prepare a mixed solution, and dissolving 1.3 M LiPF₆ in the mixed solution.

### Crack Evaluation: Observation of the Surface of an Electrode

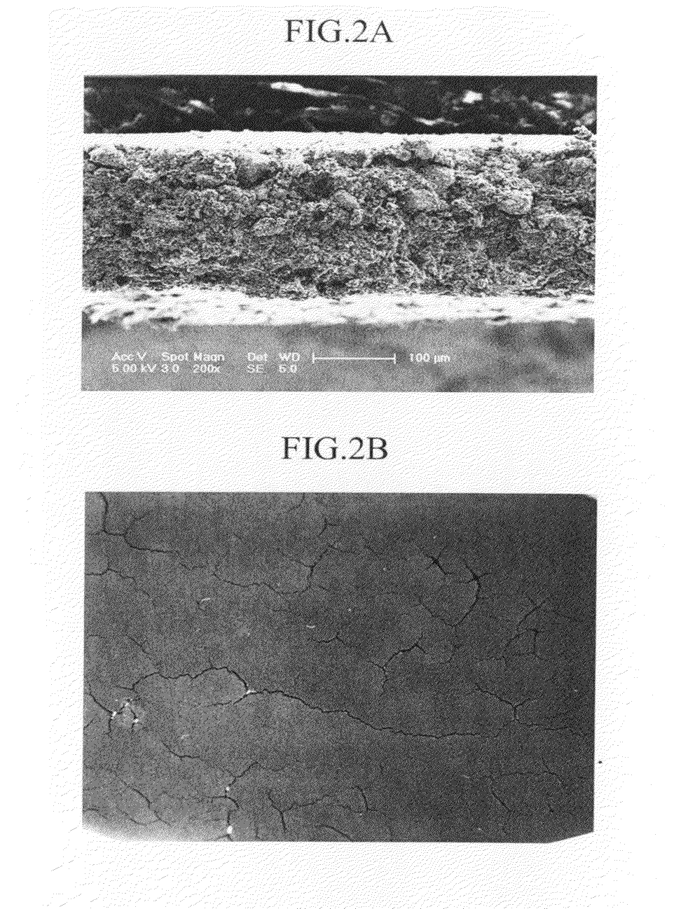

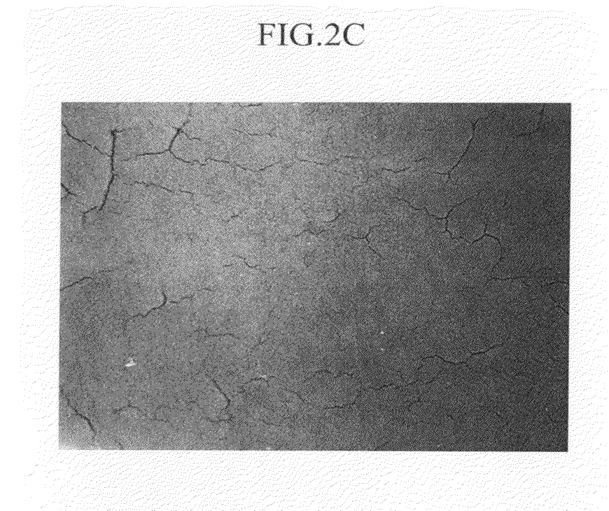

The surface of each positive electrode of Example 1 and Comparative Examples 2 to 3 was observed. The results are shown in FIGS. 2A, 2B, and 2C, respectively.

FIGS. 2A to 2C respectively show scanning electron microscope (SEM) photographs of the surface of the positive electrodes according to Example 1 and Comparative Examples 2 to 3. Referring to FIGS. 2A to 2C, the positive electrode of Example 1 had no crack while that of Comparative Examples 2 and 3 had many cracks on the surface.

### Rate Capability Evaluation

The half-cells respectively including the positive electrodes of Example 1 and Comparative Example 1 were charged and discharged once at a varying C-rate in the order shown in Table 1. Each discharge was measured to determine discharge capacity to evaluate rate capability after a given charge.

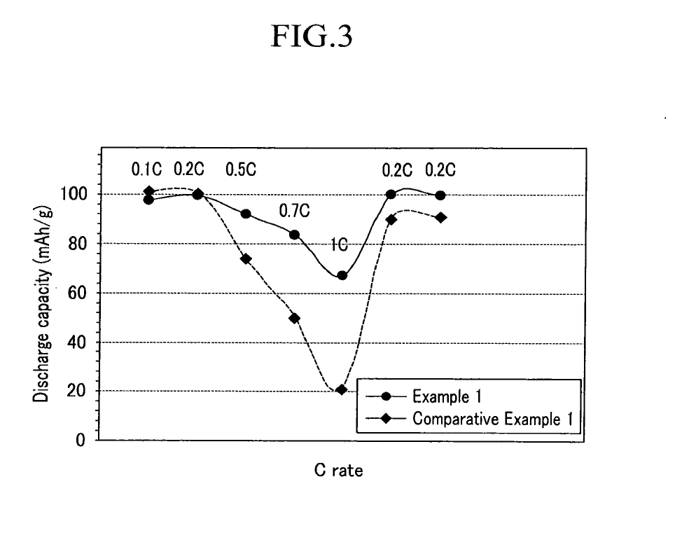

The rate capability is explained referring to Table 1 and FIG. 3. FIG. 3 is a graph showing rate capability of rechargeable lithium battery cells respectively including the electrodes according to Example 1 and Comparative Example 1.

TABLE 1

| | Discharge capacity (mAh/g) | |
|---|---|---|
| C-rate | Example 1 | Comparative Example 1 |
| 0.1 | 97.5 | 101.5 |
| 0.2 | 99.6 | 100.6 |
| 0.5 | 92.0 | 74.0 |
| 0.7 | 83.8 | 50.0 |
| 1.0 | 67.0 | 20.9 |
| 0.2 | 99.9 | 90 |
| 0.2 | 99.9 | 91 |

As shown in Table 1 and FIG. 3, the half-cells including the positive electrode of Comparative Example 1 had remarkable discharge capacity deterioration when the C-rate was 0.5 C or more. When it was charged and discharged again at 0.2 C, it had discharge capacity that was lower when compared to the initial 0.2 C charge and discharge. The rechargeable lithium battery cell including the electrode of Example 1 had a small discharge capacity decrease at a high rate of 1 C. When it was charged and discharged at 0.2 C again, it almost maintained the initial discharge capacity.

Therefore, the half-cell including the positive electrode of Example 1 had improved rate capability compared with that including the positive electrode of Comparative Example 1.

### Cycle Characteristic Evaluation

Each half-cell respectively including the electrodes of Example 1 and Comparative Example 2 was evaluated regarding cycle characteristic. Each half-cell was charged and discharged 50 times at 0.2C, and the discharge capacity was measured for each cycle to evaluate measured regarding cycle characteristic.

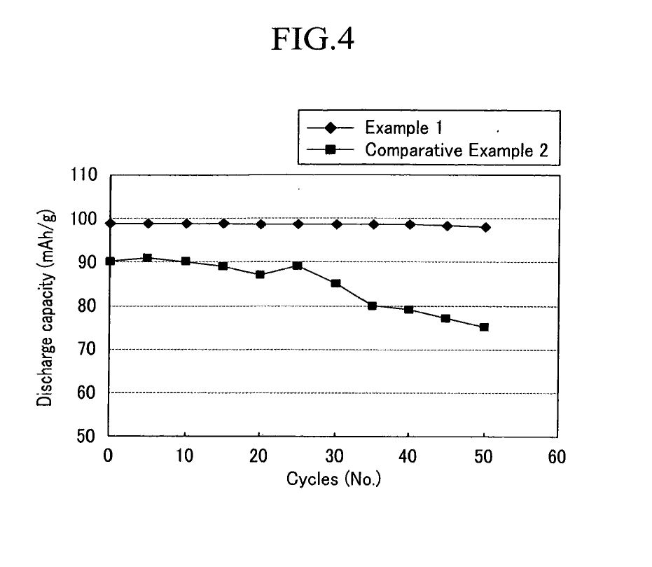

The cycle characteristic is illustrated referring to Table 2 and FIG. 4. FIG. 4 is a graph showing the cycle characteristic of half-cells respectively including the positive electrodes according to Example 1 and Comparative Example 2.

TABLE 2

| Cycle | Example 1 | Comparative Example 2 |
|---|---|---|
| number | (mAh/g) | (mAh/g) |
| 0 | 99 | 90 |
| 5 | 99 | 91 |
| 10 | 99 | 90 |
| 15 | 99 | 89 |
| 20 | 98.7 | 87 |
| 25 | 98.5 | 89 |
| 30 | 98.5 | 85 |
| 35 | 98.7 | 80 |
| 40 | 98.5 | 79 |
| 45 | 98.3 | 77 |
| 50 | 98 | 75 |

Referring to Table 2 and FIG. 4, the half-cell including the positive electrode of Example 1 had an improved cycle characteristic, while that including the positive electrode of Comparative Example 2 had remarkable discharge capacity deterioration as the cycling continued. Accordingly, the half-cell including the positive electrode of Example 1 had an improved cycle characteristic compared with that including the positive electrode of Comparative Example 2.

While certain exemplary embodiments have been illustrated and described, those of ordinary skill in the art will understand that certain modifications and changes can be made to the described embodiments without departing from the spirit and scope of the present invention, as defined in the attached claims and their equivalents.

What is claimed is:

1. An electrode for a rechargeable lithium battery, comprising:
a current collector;
a first active material layer on the current collector, the first active material layer comprising a first binder, a first active material, and a first conductive material; and
a second active material layer on the first active material layer, the second active material layer comprising a second binder comprising a polymer, a second active material, and a second conductive material.

2. The electrode of claim 1, wherein the first and second active material layers have a combined thickness of about 150 μm to about 1000 μm.

3. The electrode of claim 1, wherein the first binder comprises a material selected from the group consisting of polyvinylidene fluoride (PVdF), carboxylmethyl cellulose (CMC), a styrene-butadiene rubber (SBR), a polyimide (PI), a polyamideimide (PAI), polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, and combinations thereof.

4. The electrode of claim 1, wherein the first active material layer is about 100 μm to about 500 μm thick.

5. The electrode of claim 1, wherein the second binder comprises a copolymer of hexafluoro propylene (HFP) and a material selected from the group consisting of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, and combinations thereof.

6. The electrode of claim 5, wherein the second binder comprises hexafluoro propylene at about 1 wt % to about 20 wt % based on the weight of the second binder.

7. The electrode of claim 1, wherein the second active material layer is about 50 μm to about 500 μm thick.

8. A method of manufacturing an electrode for a rechargeable lithium battery, comprising:
preparing a first active material composition by mixing a first binder, a first active material, and a first conductive material in a first solvent;
preparing a second active material composition by mixing a second binder, a second active material, and a second conductive material in a second solvent;
coating the first active material composition on at least one side of a current collector to form a first active material layer and drying the first active material layer;
coating the second active material composition on the first active material layer to form a second active material layer and drying the second active material layer; and
compressing the second active material layer and the first active material layer on the current collector.

9. The method of claim 8, wherein the first binder comprises a material selected from the group consisting of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, and combinations thereof.

10. The method of claim 8, wherein the second binder comprises a copolymer of hexafluoro propylene (HFP) and a material selected from the group consisting of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, and combinations thereof.

11. The method of claim 8, wherein the first solvent is different from the second solvent.

12. The method of claim 11, wherein each of the first solvent and the second solvent is independently selected from the group consisting of N-methylpyrrolidone (NMP); hexane; water; alcohols; ketones; ethers; lactones; lactams; cyclic aliphatics; aromatic hydrocarbons; aliphatic hydrocarbons; linear amides; cyclic amides; esters; carbonates; aprotic solvents; and combinations thereof.

13. The method of claim 8, wherein the combined first and second active material layers are about 300 μm to about 2000 μm thick before the compression and about 150 μm to about 1000 μm thick after the compression.

14. The method of claim 8, wherein at least one of the first or second active material compositions comprises the active material at 80 wt % to 97 wt % based on the weight of the active material composition, the conductive material at 1.5 wt % to 10 wt % based on the weight of the active material composition, and the first or second binder at 1.5 wt % to 10 wt % based on the weight of the active material composition.

15. A rechargeable lithium battery comprising:
an electrode comprising:
a current collector;
a first active material layer on the current collector, the first active material layer comprising a first binder, a first active material, and a first conductive material; and
a second active material layer on the first active material layer, the second active material layer comprising a second binder comprising a polymer, a second active material, and a second conductive material.

16. The rechargeable lithium battery claim 15, wherein the first and second active material layers have a combined thickness of about 150 μm to about 1000 μm.

17. The rechargeable lithium battery of claim 15, wherein the first binder comprises a material selected from the group consisting of polyvinylidene fluoride (PVdF), carboxylmethyl cellulose (CMC), a styrene-butadiene rubber (SBR), a polyimide (PI), a polyamideimide (PAI), polyvinyl alcohol, hydroxypropyl cellulose, polyvinyl chloride, carboxylated polyvinyl chloride, polyvinyl fluoride, a polymer including ethylene oxide; polyvinylpyrrolidone, polyurethane, polytetrafluoroethylene, polyethylene, polypropylene, an acrylated styrene-butadiene rubber, an epoxy resin, and combinations thereof.

18. The rechargeable lithium battery of claim 15, wherein the first active material layer is about 100 μm to about 500 μm thick.

19. The rechargeable lithium battery of claim 15, wherein the second binder comprises a copolymer of hexafluoro propylene (HFP) and a material selected from the group consisting of polyvinylidene fluoride, carboxylmethyl cellulose, a styrene-butadiene rubber, a polyimide, a polyamideimide, polyvinyl alcohol, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyethylene, polypropylene, an acrylated styrene-butadiene rubber, an epoxy resin, and combinations thereof.

20. The rechargeable lithium battery of claim 15, wherein the second active material layer is about 50 μm to about 500 μm thick.
